(19) United States
(12) Patent Application Publication
(10) Pub. No.: US 2020/0162577 A1
(43) Pub. Date: May 21, 2020

(54) RELEVANT ADVERTISEMENT GENERATION BASED ON A USER OPERATING A CLIENT DEVICE COMMUNICATIVELY COUPLED WITH A NETWORKED MEDIA DEVICE

(71) Applicants: Ashwin Navin, San Francisco, CA (US); Michael Omar Zennadi, San Francisco, CA (US); David Harrison, Reno, NV (US)

(72) Inventors: Ashwin Navin, San Francisco, CA (US); Michael Omar Zennadi, San Francisco, CA (US); David Harrison, Reno, NV (US)

(21) Appl. No.: 16/752,611

(22) Filed: Jan. 24, 2020

Related U.S. Application Data
(63) Continuation of application No. 16/404,725, filed on May 6, 2019.
Application No. 16/404,725 is a continuation-in-part of application No. 14/139,890, filed on Dec. 24, 2013, now Pat. No. 10,334,324.
Application No. 14/139,890 is a continuation-in-part of application No. 14/018,408, filed on Sep. 4, 2013, now Pat. No. 9,589,456.
Application No. 14/018,408 is a continuation-in-part of application No. 13/943,866, filed on Jul. 17, 2013, now Pat. No. 8,819,255.
Application No. 13/943,866 is a continuation of application No. 13/904,015, filed on May 28, 2013, now Pat. No. 9,026,668.
Application No. 13/904,015 is a continuation-in-part of application No. 13/736,031, filed on Jan. 7, 2013, now Pat. No. 9,154,942.
Application No. 13/904,015 is a continuation-in-part of application No. 13/470,814, filed on May 14, 2012, now Pat. No. 8,539,072.
Application No. 13/470,814 is a continuation of application No. 12/592,377, filed on Nov. 23, 2009, now Pat. No. 8,180,891.
(60) Provisional application No. 61/696,711, filed on Sep. 4, 2012.
(60) Provisional application No. 61/803,754, filed on Mar. 20, 2013.
(60) Provisional application No. 61/652,153, filed on May 26, 2012.
(60) Provisional application No. 61/584,168, filed on Jan. 6, 2012.
(60) Provisional application No. 61/118,286, filed on Nov. 26, 2008.

(51) Int. Cl. H04L 29/08; G06F 21/53; H04L 29/06; G10L 25/48; G06Q 30/02; H04W 8/00

(52) U.S. Cl. CPC H04L 67/306; H04L 67/16; G06F 21/53; H04L 67/42; G06F 2221/2119; G10L 25/48; G06Q 30/0261; H04W 8/005; H04L 67/22

(57) ABSTRACT

A server includes a memory, and a processor communicatively coupled to the memory. The processor is configured to execute instructions to receive a request for content for a client device, match a targeted data to the identification information based on a relevancy factor, and provide the targeted data to a sandboxed application of the client device configured to render the targeted data. The request includes identification information, which is a user identification information or a device identification information for the client device. The identification information is associated with a content identification data or a content identification history generated from preliminary data generated by a networked device associated with the client device.

### CLAIM OF PRIORITY

This patent application is a Continuation Application of, and, hereby, incorporates the entirety of the disclosures of, and claims priority to each of, the following cases:

U.S. Continuation-in-Part patent application Ser. No. 16/404,725 titled RELEVANT ADVERTISEMENT GENERATION BASED ON A USER OPERATING A CLIENT DEVICE COMMUNICATIVELY COUPLED WITH A NETWORKED MEDIA DEVICE filed on May 6, 2019, which is a Continuation-in-Part application of:

U.S. Continuation-in-Part patent application Ser. No. 14/139,890 titled RELEVANT ADVERTISEMENT GENERATION BASED ON A USER OPERATING A CLIENT DEVICE COMMUNICATIVELY COUPLED WITH A NETWORKED MEDIA DEVICE filed on Dec. 24, 2013 and issued as U.S. Pat. No. 10,334,324 on Jun. 25, 2019, which is a Continuation-in-Part application of and claims priority to:
(1) U.S. Continuation-in-Part patent application Ser. No. 14/018,408 titled EXPOSURE OF PUBLIC INTERNET PROTOCOL ADDRESSES IN AN ADVERTISING EXCHANGE SERVER TO IMPROVE RELEVANCY OF ADVERTISEMENTS filed on Sep. 4, 2013 and now issued as U.S. Pat. No. 9,589,456 on Mar. 7, 2017,
   which claims priority to U.S. Provisional Patent Application No. 61/696,711 titled SYSTEMS AND METHODS OF RECOGNIZING CONTENT filed on Sep. 4, 2012,
(2) U.S. Provisional Patent Application No. 61/803,754 titled APPLICATIONS OF ZEROCONF BIDIRECTIONAL COMMUNICATIONS BETWEEN A NETWORKED DEVICE AND A SECURITY SANDBOX COMPRISING TARGETED ADVERTISEMENT, ENVIRONMENT AWARENESS, USER MAPPING, GEOLOCATION SERVICES, AND CONTENT IDENTIFICATION filed on Mar. 20, 2013, and
(3) U.S. Continuation-in-Part patent application Ser. No. 13/943,866 titled RELEVANCY IMPROVEMENT THROUGH TARGETING OF INFORMATION BASED ON DATA GATHERED FROM A NETWORKED DEVICE ASSOCIATED WITH A SECURITY SANDBOX OF A CLIENT DEVICE filed on Jul. 17, 2013 and issued as U.S. Pat. No. 8,819,255 on Aug. 26, 2014,
   which further is a continuation patent application of U.S. patent application Ser. No. 13/904,015 titled REAL-TIME AND RETARGETED ADVERTISING ON MULTIPLE SCREENS OF A USER WATCHING TELEVISION filed on May 28, 2013 and issued as U.S. Pat. No. 9,026,668 on May 5, 2015,
      which further claims priority to U.S. Provisional Patent Application No. 61/652,153 titled CONTENT RECOGNITION SYSTEM filed on May 26, 2012, which further is a Continuation-in-Part patent application of U.S. patent application Ser. No. 13/736,031 titled ZERO CONFIGURATION COMMUNICATION BETWEEN A BROWSER AND A NETWORKED MEDIA DEVICE filed on Jan. 7, 2013 and issued as U.S. Pat. No. 9,154,942 on Oct. 6, 2015,
         which further claims priority to U.S. Provisional Patent Application No. 61/584,168 titled CAPTURING CONTENT FOR DISPLAY ON A TELEVISION and filed on Jan. 6, 2012, and
         which further is a Continuation-in-Part patent application of U.S. patent application Ser. No. 13/470,814 titled GENERATION OF A TARGETED ADVERTISEMENT IN AN UNTRUSTED SANDBOX BASED ON A PSEUDONYM filed on May 14, 2012 and issued as U.S. Pat. No. 8,539,072 on Sep. 17, 2013,
         which itself is a Continuation patent application of U.S. patent application Ser. No. 12/592,377 titled DISCOVERY, ACCESS CONTROL, AND COMMUNICATION WITH NETWORKED SERVICES FROM WITHIN A SECURITY SANDBOX, filed on Nov. 23, 2009 and issued as U.S. Pat. No. 8,180,891 on May 15, 2012,
         which claims priority to U.S. Provisional Patent Application No. 61/118,286 titled DISCOVERY, ACCESS CONTROL, AND COMMUNICATION WITH NETWORKED SERVICES FROM WITHIN A SECURITY SANDBOX filed on Nov. 26, 2008.

### FIELD OF TECHNOLOGY

This disclosure relates generally to the technical field of advertising, and in one example embodiment, this disclosure relates to a method, an apparatus and/or a system related to relevant advertisement generation based on a user operating a client device communicatively coupled with a networked media device.

### BACKGROUND

An advertiser may be a single party advertiser, an aggregate of advertisers, and/or an advertisement agency. The advertiser may target advertisements to a user through any number of mediums, such as a television channel, a webpage of a client device, and/or a mobile application. Advertisements for the same or similar products may be more effective when targeted to the user through multiple mediums and within a specific time frame. However, the advertiser may have trouble identifying which televisions and/or client devices are associated with the user at a given time. In addition, the advertiser may be unaware of when an particular advertisement is displayed on a television associated with the user. Therefore, it may be difficult for the advertiser to target an advertisement of the same or similar product to a client device of the user within the specific time frame.

### SUMMARY

Disclosed are a method, an apparatus and/or a system related to delivery of a targeted advertisement to a client device based on relevant advertisement generation based on a user operating a client device communicatively coupled with a networked media device.

In one aspect, a server includes a memory, and a processor communicatively coupled to the memory. The processor is configured to execute instructions to receive a request for content for a client device, match a targeted data to the identification information based on a relevancy factor, and provide the targeted data to a sandboxed application of the client device configured to render the targeted data. The request includes identification information, which is a user identification information or a device identification information for the client device. The identification information is associated with a content identification data or a content identification history generated from preliminary data generated by a networked device associated with the client device.

In another aspect, a method of a server includes receiving through a network a request for content for a client device including identification information, storing the request in a memory, and, through a processor communicatively coupled to the memory, matching a targeted data to the identification information based on a relevancy factor, and providing the targeted data to a sandboxed application of the client device configured to render the targeted data. The identification information is a user identification information or a device identification information for the client device. The identification information is associated with a content identification data or a content identification history generated from preliminary data generated by a networked device associated with the client device.

In yet another aspect, a system includes a content identification server including a first memory and a first processor communicatively coupled to the first memory. The first processor is configured to execute instructions to receive fingerprint data generated at regular intervals by a networked device, generate content identification data from the received fingerprint data, and associate the content identification data with a device identification information or a user identification information. The system also includes a relevancy-matching server including a second memory and a second processor communicatively coupled to the second memory.

The second processor is configured to execute instructions to receive a request for content for a client device associated with the networked device, match a targeted data to the device identification information or the user identification information based on the association of the device identification information or the user identification information with the content identification data, and provide the targeted data to the client device through a sandboxed application of the client device configured to render the targeted data. The request includes the device identification information or the user identification information associated with the content identification data.

Further, in one aspect, a method includes, through a content identification server including a first memory and a first processor communicatively coupled to the first memory, the first processor receiving fingerprint data generated at regular intervals by a networked device, the first processor generating content identification data from the received fingerprint data, and the first processor associating the content identification data with a device identification information or a user identification information.

The method also includes, through a relevancy-matching server including a second memory and a second processor communicatively coupled to the second memory, the second processor receiving a request for content for a client device associated with the networked device including the device identification information or the user identification information associated with the content identification data, and the second processor, in response to the request for content, matching a targeted data to the device identification information or the user identification information based on the association of the device identification information or the user identification information with the content identification data, and providing the targeted data to the client device through a sandboxed application of the client device configured to render the targeted data.

The methods and systems disclosed herein may be implemented in any means for achieving various aspects, and may be executed in a form of a non-transitory machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF DRAWINGS

Example embodiments are illustrated by way of example and not limitation in the Figure of the accompanying drawing, in which like references indicate similar elements and in which:

FIG. 1 is a block diagram of a system of targeted advertising to a client device, through an application, based on an advertisement displayed on a television, according to one embodiment.

FIG. 2 is a block diagram of a system of targeted advertising to a client device, through a web browser, based on an advertisement displayed on a television, according to one embodiment.

FIG. 3 is a block diagram of a system of discovery, through an application, of a television networked to a client device and targeted advertising to the client device, according to one embodiment.

FIG. 4 is a block diagram of a system of discovery, through a web browser, of a television networked to a client device and targeted advertising to the client device, according to one embodiment.

FIG. 5 is an exploded view of the television of FIG. 1, according to one embodiment.

FIG. 6A-B are block diagrams of a system of targeted advertising to a client device based on an advertisement displayed on a television, wherein the advertisement is identified based on a channel the television is tuned to, according to one embodiment.

FIGS. 7A-B are block diagrams of a system of targeted advertising to a client device, through an ad exchange, based on an advertisement displayed on a television, according to one embodiment.

Other features of the present embodiments will be apparent from the accompanying drawings and from the detailed description that follows.

### DETAILED DESCRIPTION

A method, an apparatus and/or a system related to delivery of a targeted advertisement to a client device based on relevant advertisement generation based on a user operating a client device communicatively coupled with a networked media device.

In one embodiment, a method includes determining that a user 180 is likely viewing a television 110 and/or accessing a client device while viewing the television 110, determining that the content currently being displayed on the television 110 is associated with a motion-video advertisement (e.g., the advertisement 160 in an embodiment of a television commercial) through an automatic content recognition algorithm applied to the television 110, selecting an alphanumeric advertisement formatted for a display area of the client device based on contextual match between the motion-video advertisement (e.g., the advertisement 160) and/or the alphanumeric advertisement (e.g., a text and/or image advertisement), and delivering the alphanumeric advertisement to the client device while the motion-video advertisement (e.g., the advertisement 160) is still rendering on the television 110.

The method may constrain an executable environment in a security sandbox (e.g, in a web browser). The method may executing a sandboxed application in the executable environment. The method may automatically instantiating a connection between the sandboxed application and/or a sandbox reachable service of the networked media device. In addition, the method may determining what content is being shown on the networked media device. The method may select an advertisement to be downloaded on the client device based on a contextual match between the advertisement and/or the content being shown on the networked media device, wherein the alphanumeric advertisement is a textual advertisement, a display advertisement, and/or an audio-visual advertisement.

The method may determine that the user 180 has interacted with the alphanumeric advertisement when the user 180 selects a hyperlink in the alphanumeric advertisement. The method includes displaying the motion-video advertisement (e.g., the advertisement 160) on the television 110 based on the determination that the user 180 has interacted with the alphanumeric advertisement by selecting the hyperlink in the alphanumeric advertisement.

A user may use a client device and a watch a television at the same time. The client device may be a laptop, tablet, mobile phone, or any other portable electronic device. The television may be tuned to a terrestrial broadcast, a satellite channel, or a cable channel. The television may stream content over a television network (e.g. a terrestrial broadcast network, a satellite network, or a cable television network) or an internet protocol (IP) network. In one example, the television may receive a video stream from an internet service (e.g. Hulu, Crunchyroll, etc.) over the IP network. The television may display a first advertisement. An association of the client device and the television with each other and/or with the user may be inferred by a number of methods, as disclosed in a number of embodiments and Figures herein. An advertiser (e.g. a single-party advertiser, an aggregate of advertisers, and/or an advertisement agency) may desire to target a second advertisement to the client device based on the first advertisement and/or the inferred association.

In one or more embodiments, the client device and the television may both be inferred to be associated with each other and/or with the user. The association may be inferred based on a geospatial proximity, a shared public IP address, a shared public IP address range, a base station MAC address, a base station service set identifier (base station BSSID), a direct pairing, and/or a shared identifier. Geospatial proximity may be inferred by GPS. Alternatively or in addition, geospatial proximity may be inferred by mutual visibility of a base station BSSID and/or base station MAC address (even if the client device 100 and/or the television 110 cannot connect or communicate through the base station). The shared identifier may be a globally unique identifier (GUID), a session ID, a username and/or password, an ephemeral GUID, a short code, a quick response code (QR code) or any combination thereof. In addition or alternatively, the association may be inferred based on a discovery protocol, such as a redirect (e.g. a redirect of a browser or application that specifies a private IP of a television that may be associated with the client device), a multicast protocol (e.g. a simple service discovery protocol (SSDP)), and/or a broadcast protocol. Other discovery protocols are within the scope of the embodiments disclosed herein. The discovery protocol may establish whether the client device and television are currently connected to the same network (e.g. through a private network, via LAN, and/or by direct pairing) or whether the client device can view a network the television is connected to. In one or more embodiments, the association may be inferred based, at least in part, on a previously inferred association. For example, if at one time, an association of a client device at an original geolocation and a television with a user is inferred based on a shared user ID of the client device and the television, the association may later be inferred simply by geospatial proximity of the client device to the original geolocation.

In one or more embodiments, the television may display the first advertisement. The first advertisement may be identified by automatic content recognition (ACR) and/or an advertisement identification module run on the television and/or run on a server of a network the television is connected to. Alternatively, the ACR may be an audio ACR run on a client device within hearing range of a television. This would be useful for identifying an advertisement played on a television without an ACR. The identified first advertisement may be catalogued on the server, or on another server. Further, the identified first advertisement may be associated with a time stamp.

In one or more embodiments, the second advertisement may be targeted to the client device based on the identified first advertisement. The second advertisement may be targeted within a time threshold of the time stamp. The second advertisement may share a brand, service, product, and/or product line with the identified first advertisement. In one or more embodiments, the second advertisement may be interactive (e.g. may allow the user to navigate to a website, participate in a survey, claim a coupon or incentive, etc.).

In one or more embodiments, the ACR module may be used to identify other content besides or in addition to advertisements, such as objects, people, and/or locations featured on a channel the television is tuned to. The second advertisement may be determined, at least in part, based on the other content. For example, a television may display a car show. The second advertisement may be an advertisement for a car model and/or brand.

The inferred association between the client device and the television, the identification, cataloging and time stamping of the first, and the targeting of the second advertisement to the client device may be performed by one or more servers connected to the client device and/or television across a network. A number of servers, with various databases and modules, are illustrated in the Figures. The servers are organized by function, although one or more of the servers may be part of the same server. Further, different organization of the databases and modules between servers are within the scope of the embodiments disclosed herein.

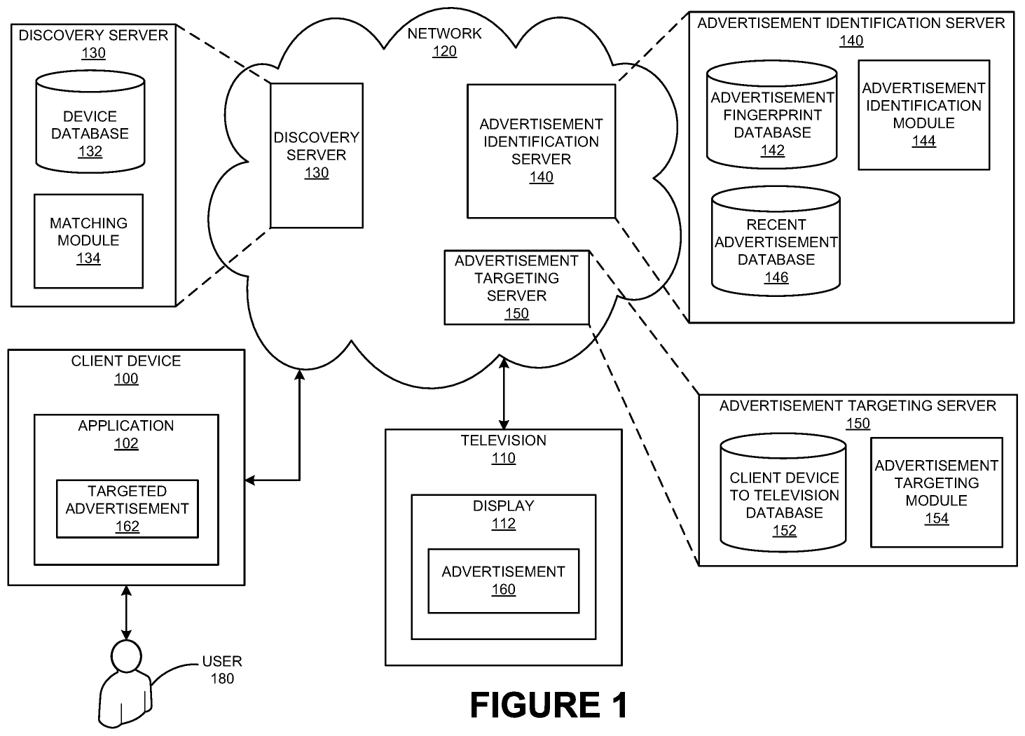

Reference is now made to FIG. 1, which is a block diagram of a system of targeted advertising to a client device 100, through an application 102, based on an advertisement 160 displayed on a television 110. The client device 100 may be a laptop, tablet, mobile phone, or any other portable electronic device. The client device 100 may comprise an application 102. The application 102 may or may not be sandboxed. The television 110 may comprise a display 112. The advertisement 160 displayed by the television 110 may be a video advertisement, an overlay advertisement, and/or a placement advertisement. The client device 100 and the television 110 may be coupled to a network 120, such as a wide area network (WAN) and/or an IP network. The television 110 may, over a television network (e.g. the network 120 or another network such as an IP network or a television network), stream content that contains advertisements. The network 120 may comprise one or more servers involved in targeted advertising to the client device 100 based on the advertisement 160 displayed on the television 110.

In one or more embodiments, the network 120 may comprise a discovery server 130. The discovery server 130 may comprise a device database 132 that stores device-identification data (i.e. data useful for identifying the client device 100 and/or the television 110). The device-identification data may be a current or previous geospatial proximity, a public IP address, a public IP address range, a service set identifier (SSID), a base station MAC address, a base station service set identifier (base station BSSID), a direct pairing, a globally unique identifier (GUID), a session ID, a username and/or password, an ephemeral GUID, a short code, a quick response code (QR code) or any combination thereof. A matching module 134 of the discovery server 130 may infer an association between the client device 100 and the television 110 based on a shared device-identification data. The inferred association between the client device 100 and the television 110 may be an inferred connectivity of the client device 100 to the television 110 and/or an inferred association of both the client device 100 and the television 110 with a user 180. In one or more embodiments, the application 102 may communicate device-identification data to the discovery server 130 to be stored in the device database 132.

In one example, the user 180 may input a username and/or short code to both the client device 100 and the television 110 (e.g. at the same time or at different times). The username and/or short code associated with the client device 100 and the username and/or short code associated with the television 110 may be stored on the device database 132. The matching module 134 may infer an association between the client device 100 and the television 110 based on the username and/or short code shared by the client device 100 and the television 110.

In another example, a short code may be displayed on the television 110 based on an inferred proximity of the client device 100 to the television 110. The client device 100 may prompt the user 180 to input and/or confirm the short code displayed on the television 110. An association between the client device 100 and the television 110 may then be inferred by the matching module 134, based on the user 180 input and/or confirmation of the short code presented on the television 110.

In another example, when the user 180 uses the application 102 to take a picture of a QR code displayed on the television 110, the application 102 may communicate the QR code to the discovery server 130. The matching module 134 may infer an association between the client device 100 and the television 110 based on the QR code shared by the client device 100 and the television 110. Examples of using other device-identification data and/or combinations of device-identification data to infer an association between the client device 100 and the television 110 are within the scope of the embodiments disclosed herein.

In one or more embodiments, the network 120 may further comprise an advertisement identification server 140. The advertisement identification server 140 may identify an advertisement 160 displayed on the television 110. The advertisement identification server 140 may comprise an advertisement fingerprint database 142. The advertisement fingerprint database 142 may store fingerprints (e.g. image fingerprints, audio fingerprints, video fingerprints and/or a series of fingerprints thereof) associated one or more advertisements. The television 110 may communicate fingerprints of the advertisement 160 to the advertisement identification server 140. An advertisement identification module 144 may identify the advertisement 160 based on a matching of the fingerprints of the advertisement 160 to fingerprints within the advertisement fingerprint database 142. Further, the advertisement identification module may also account for noise, changes to aspect ratio, and/or other transformations that may complicate the identification of the advertisement 160. The advertisement identification module 144 may catalogue (i.e. store information relating to) the advertisement 160 in a recent advertisement database 146. The advertisement identification module 144 may further associate a time stamp with the advertisement 160.

In one or more embodiments, the fingerprints stored in the advertisement fingerprint database 142 may be provided by one or more advertisers. Alternatively or in addition, the fingerprints stored in the advertisement fingerprint database 142 may be provided by an algorithm that infers an advertisement based on the fingerprints provided by the television 110. For example, a sequence of image fingerprints may be inferred to be an advertisement based on repetition.

In one or more embodiments, the network 120 may further comprise an advertisement targeting server 150. The advertisement targeting server 150 may comprise a client device to television database 152. The client device to television database 152 may comprise inferred associations between client devices and televisions (e.g. inferred direct coupling, inferred connectivity through a network, and/or inferred association with the same user). In one embodiment, the client device to television database 152 may be generated by the matching module 134. The advertisement targeting server 150 may further comprise an advertisement targeting module 154. The advertisement targeting module 154 may access the client device to television database 152 and/or the recent advertisement database 146. The advertisement targeting module 154 may target an advertisement 162 to the client device 100 based on an identified advertisement (e.g. the advertisement 160) displayed on a television (e.g. the television 110) inferred to be associated with the client device. The advertisement targeting module 154 may target the advertisement 162, through the application 102, to the client device 100.

In one or more embodiments, the advertisement 162 may feature a same or similar product, product line, and/or brand as featured by the advertisement 160. The advertisement 162 may be a video advertisement, audio advertisement, overlay advertisement, image advertisement, banner advertisement, placement advertisement, interactive advertisement and/or a continuation advertisement (e.g. an advertisement that refers to content in the advertisement 160).

Alternatively or in addition, the advertisement 162 may be a competitor advertisement and/or a rebuttal advertisement. In one example of a competitor advertisement, the advertisement 160 may be for a car model of one brand and the advertisement 162 may be for a car model of a competing brand. In one example of a rebuttal advertisement, the advertisement 160 may make a claim of superiority over another brand and the advertisement 162 may respond to the claim of superiority. In one or more embodiments, the determination of advertisement 162 may be offered to the advertiser behind the advertisement 160, before being offered to a competitor of the advertiser.

In one or more embodiments, the application 102 may be configured by a software development kit (SDK) to receive and display the advertisement 162 from the advertisement targeting module 154. In one or more embodiments, the advertisement targeting module 154 may target the advertisement 162 to the client device within a time threshold of the time stamp.

In one example, an inferred association between the client device 100 and the television 110 may be stored in the client device to television database 152. The advertisement 160 may be identified, catalogued in the recent advertisement database 146, and/or time stamped by the advertisement identification module 144. The advertisement targeting module 154 may target the advertisement 162, based on the client device to television database 152 (i.e. inferred association between the client device 100 and the television 110) and the recent advertisement database 146 (i.e. the identified advertisement 160), to the client device 100 through the application 102.

In one or more embodiments, the advertisement 162 may be interactive (e.g. allow the user to respond to a survey, navigate the user to the advertiser's website, etc.). For example, the advertisement 162 may prompt the user 180 to share whether he or she recognizes the product, product line, and/or brand featured in the advertisement 160. A survey of brand recognition may serve as a measure of the success of the advertisement 160.

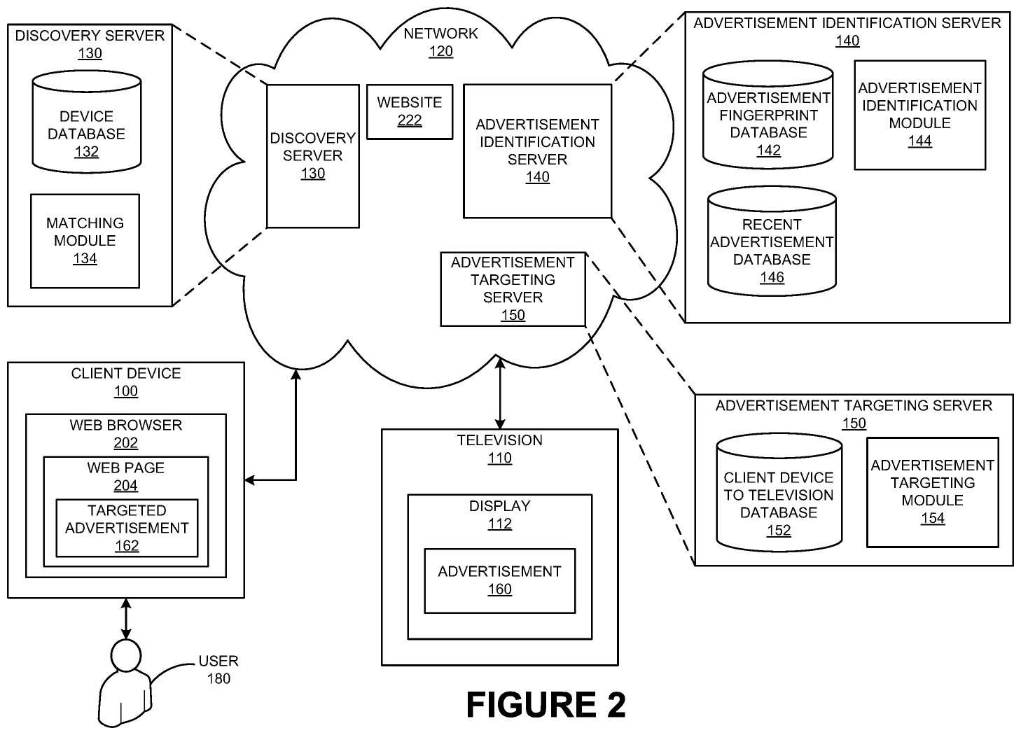

Reference is now made to FIG. 2, which is a block diagram of a system of targeted advertising to the client device 100, through a web browser 202, based on the advertisement 160 displayed on the television 110. The web browser 202 may be directed to a website 222 on the network 120 and may display a web page 204 on the client device 100. In one or more embodiments, the website 222 may communicate, or may direct the web browser 202 to communicate, device-identification data to the discovery server 130 to be stored in the device database 132.

In one or more embodiments, The advertisement targeting module 154 may target the advertisement 162 to the web page 204. In one or more embodiments, the website 222 may be configured by a software development kit (SDK) to receive the targeted advertisement 162 from the advertisement targeting module 154 and/or display the targeted advertisement 162 on the web page 204. The advertisement targeting module may target the advertisement 162, based on the client device to television database (i.e. inferred association between the client device 100 and the television 110) and the recent advertisement database 146 (i.e. the identified advertisement 160).

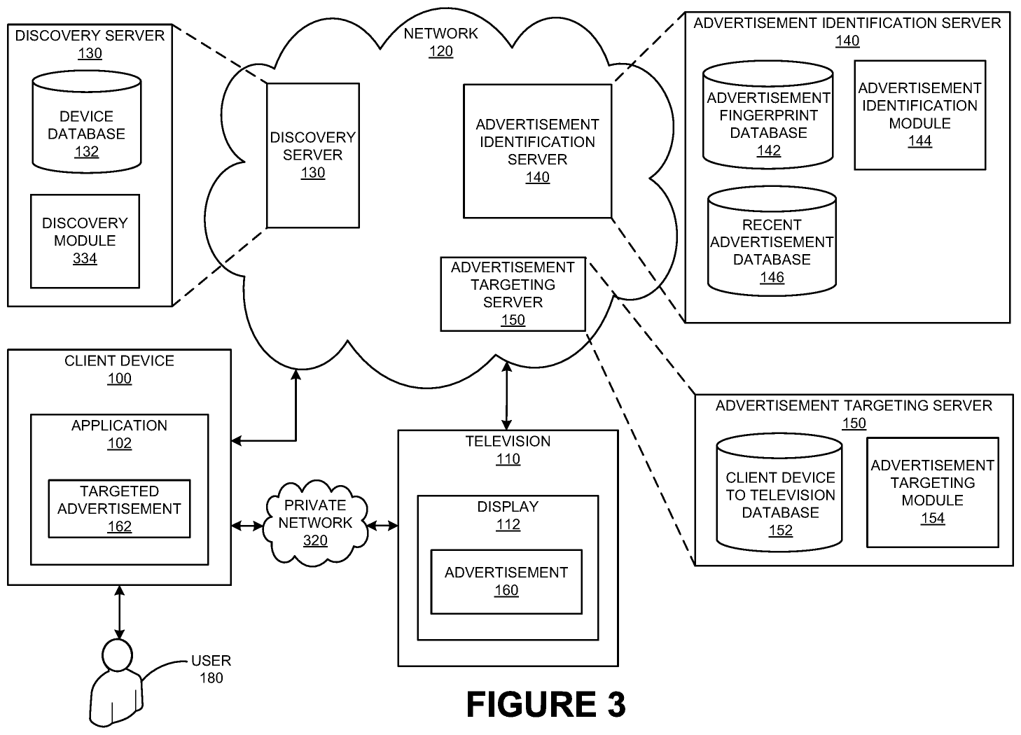

Reference is now made to FIG. 3, which is a block diagram illustrating a system of discovery, through the application 102 of a client device 100, of the television 110 connected to a private network 320. The private network 320 may be one or more LANs and/or wireless LANs (WLANs), and may span a single room or multiple buildings in proximity. The client device 100 and/or television 110 may be coupled to the private network 320, capable of connecting to the private network 320, and/or capable of viewing a wireless base station of the private network 320, any of which may allow an inferred association between the client device 100 and the television 110.

In one or more embodiments, the discovery server 130 of the network 120 may comprise a discovery module 334. The discovery module 334 may access information about one or more devices (e.g. the client device 100 and/or the television 110) from the device database 132. In one or more embodiments, the discovery module 334 and/or the application 102 may instruct the client device 100 (e.g. through the application 102) to attempt to establish a communication with the television 110 through the private network 320. The television 110 may provide an advertisement identification service (e.g. an ACR). The discovery module 334 and/or the application 102 may instruct the client device 100 to perform a broadcast and/or multicast (e.g. a user datagram protocol (UDP) or a pragmatic general multicast (PGM)) based discovery to establish the communication. The application 102 may report whether the communication was established to the discovery module 334.

In one or more embodiments, the application 102 may employ the broadcast or the multicast based discovery independent of any previously inferred association between the client device 100 and the television 110. For example, the application 102 may automatically employ the broadcast or the multicast based discovery every time the application 102 is run on the client device 100.

In one or more embodiments the client device 100 may be configured to view an identifying signal from a base station (e.g. an airport base station, a base station MAC address, a base station BSSID, etc.), television (e.g. WiFi direct MAC address), and/or an SSID. In one or more embodiments, the client device 100 may report a viewed base station (e.g. e.g. one or more of the viewed base station's MAC address, BSSID, etc.) and/or a viewed television 110 (e.g. one or more of WiFi Direct MAC address, BSSID and SSID or the television's 110 Bluetooth MAC address of the television 110) to the device database 132.

In one or more embodiments, the discovery module 334 may match the client device 100 to the television 110 based on the viewed base station's MAC address, BSSID and/or SSID, or based on a WiFi Direct MAC address, BSSID, and/or SSID. In one or more embodiments the client device 100 may be configured to automatically search for viewable base stations and/or SSID addresses.

In one or more embodiments, the client device 100 and the television 110 may report to the device database 132 any visible wirelessly broadcast identifier that may then be used as a landmark regardless of whether the signal emits from a base station, the television 110, or any other device. The discovery module 334 may match the client device 100 to the television 110 based on the landmark visible to both the client device and the television 110, even if the client device 100 and/or television 110 cannot otherwise connect to and/or communicate with the landmark.

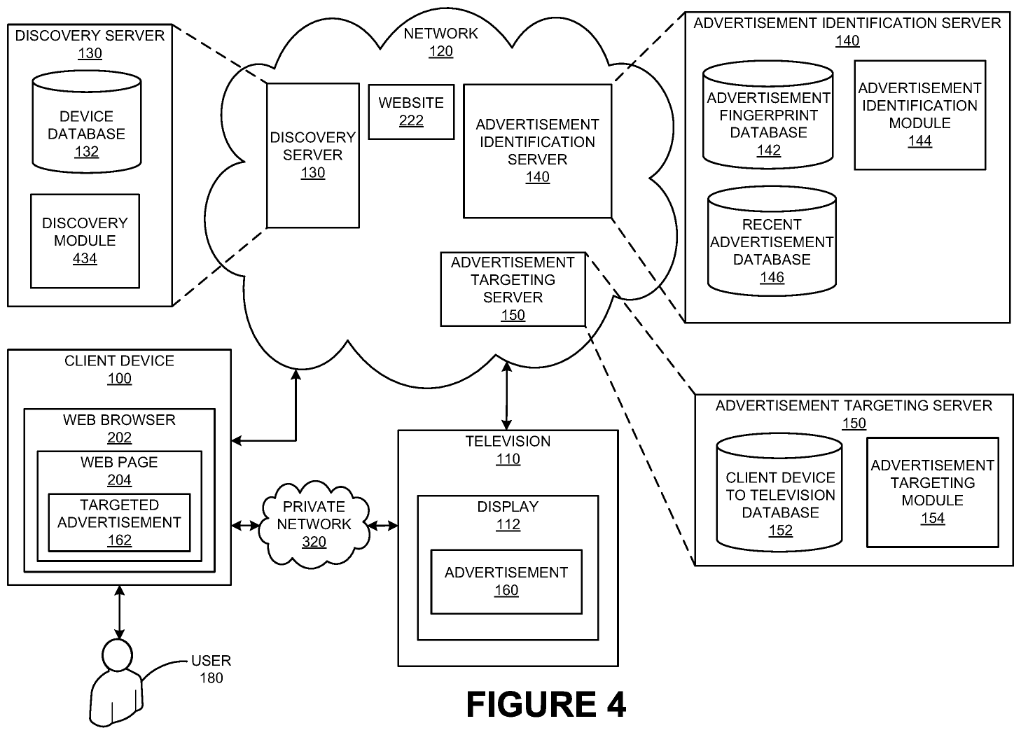

Reference is now made to FIG. 4, which is a block diagram illustrating a system of discovery, through the web browser 202 of the client device 100, of the television 110 connected to a private network 320. The private network 320 may be one or more LANs, and may span a single room or multiple buildings in proximity. The client device 100 may be coupled to the private network 320, capable of connecting to the private network 320, and/or capable of viewing a wireless base station of the private network 320, any of which may allow an inferred association between the client device 100 and the television 110.

In one or more embodiments the television 110 may have a private IP address. Further, the private IP address of the television 110 may be stored as device identification data in the device database 132 of the discovery server 130. In one or more embodiments, the discovery module 434 may infer the possibility that the client device 100 is in proximity and/or has access to the television 110 based on one or more device-identification data. Examples of device-identification data are provided in the discussion of FIG. 1.

In one or more embodiments, the website 222 may redirect the web browser 202 to the private IP address of the television 110. The television may report the redirect to the discovery module 434 (thus confirming an association between the client device 100 and the television 110) and/or may store a record of the association between the client device 100 and the television 110 in the client device to television database 152. Alternatively, the television 110 my redirect the web browser 202 to the discovery server 130 and/or the discovery module 434 of the discovery server 130. In one or more embodiments, the television 110 may redirect the web browser to the discovery module 434.

In one or more embodiments, the website 222 and/or additional websites may redirect the web browser to other private IP addresses, thus employing a trial and error method of discovery.

In one or more embodiments an image tag dropped on the website may redirect the web browser to the private IP address of the television 110. In one or more embodiments, the website 222 may sync a cookie with an ID (e.g. Google ID (GID), GUID, etc.). The synced cookie and ID may be present in the HTTP address of a redirect. Upon redirection of the browser to the television 110 based on the private IP address, the television may report the cookie and ID to the discovery module 434 and/or may store a record of the association between the client device 100 and the television 110 in the client device to television database 152.

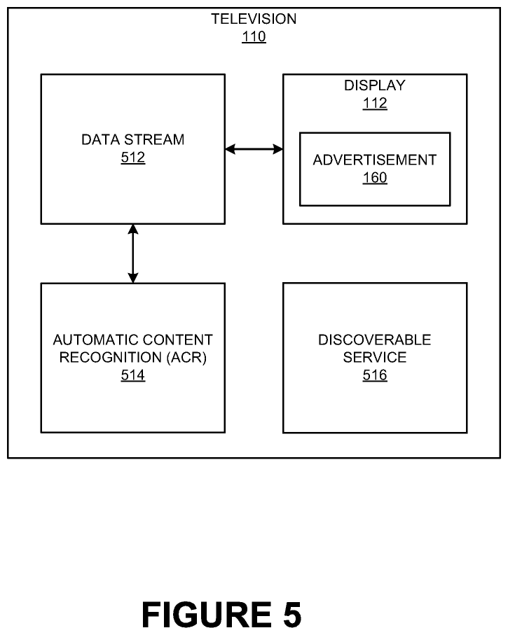

Reference is now made to FIG. 5, which is an exploded view of the television 110 of FIG. 1. The television 110 may receive a data stream 512 from a television network (e.g. a terrestrial broadcast network, a satellite network, or a cable television network) or an internet protocol (IP) network. The data stream 512 may be audio and/or video data. Video data may be rendered on the display 112 of the television 110. The television 110 may render an advertisement 160, sent over the data stream 512, on the display 112.

In one or more embodiments, the television may comprise an automatic content recognition (ACR) 514. The ACR 514 may have access to the data stream 512. For example, the ACR 514 may access video data through a frame buffer of the television 110. The ACR 514 may extract one or more fingerprints (e.g. image fingerprints, audio fingerprints, video fingerprints and/or a series of fingerprints thereof) from the data stream 512.

In one example, a video fingerprint may be a fingerprint of a series of images. The video fingerprint may comprise motion vectors and/or other features that deal with the differences between frames or a sequence of frames.

In one or more embodiments, the ACR 514 may send the fingerprints to the advertisement identification module 144 of FIG. 1. The ACR 514 and/or the advertisement identification module 144 may account for noise, changes to aspect ratio, and other transformations that may complicate the identification of the advertisement 160.

In one or more embodiments, the advertisement identification module 144 may identify the advertisement 160 displayed by the television 110 by comparing the fingerprints to the advertisement fingerprint database 142. The advertisement identification module 144 may further catalogue (i.e. store information relating to) the advertisement 160 in the recent advertisement database 146. In one embodiment, the fingerprints may be a series of image fingerprints. In one or more embodiments, new fingerprints may be extracted (e.g. at the advertisement identification server 140) from whole image data, video, audio, and/or fingerprints generated by the ACR 514. The new fingerprints may then be communicated to the advertisement identification module 144.

In one or more embodiments, the television 110 may further comprise a discoverable service 516. The discoverable service 516 may enable the application 102 of FIG. 3 and/or the web page 204 of FIG. 4 to discover the television 110. The application 102 and/or the web page 204 may or may not be sandboxed. In another embodiment, the discoverable service 516 may report to the device database 132 of FIG. 1 any visible wirelessly broadcast identifier that may then be used as a landmark regardless of whether the signal emits from a base station, the television 110, or any other device. Alternatively or in addition, the discoverable service 516 may report a viewed base station (e.g. one or more of the viewed base station's MAC address, BSSID, etc.) and/or a viewed television 110 (e.g. one or more of WiFi Direct MAC address, BSSID and SSID or the television's 110 Bluetooth MAC address of the television 110) to the device database 132.

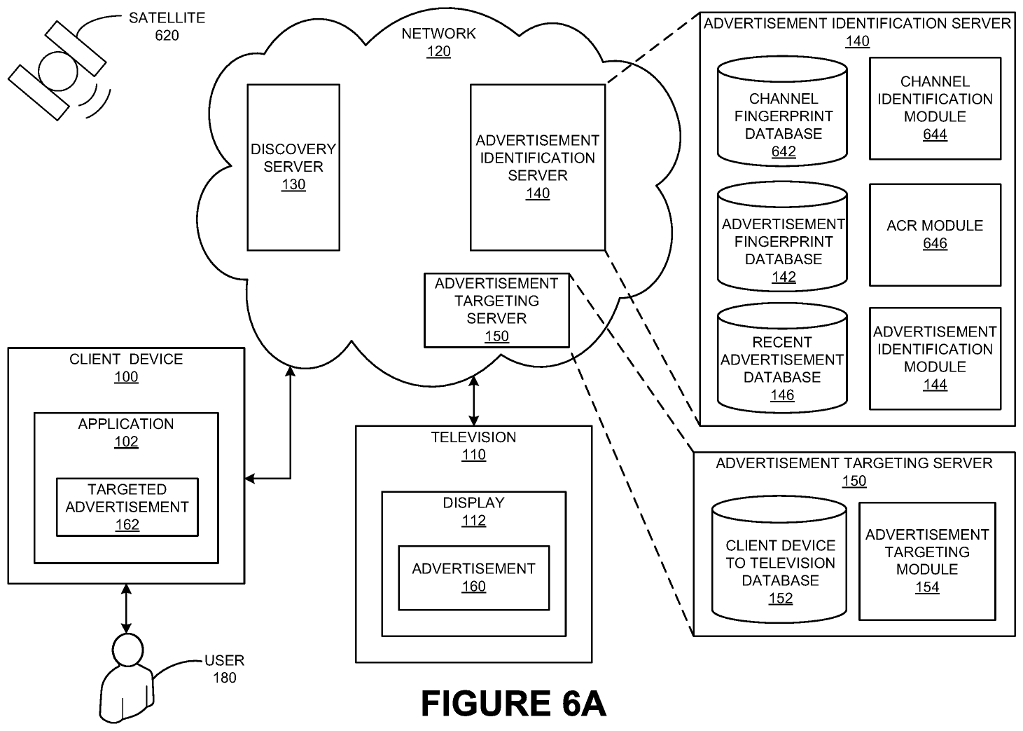

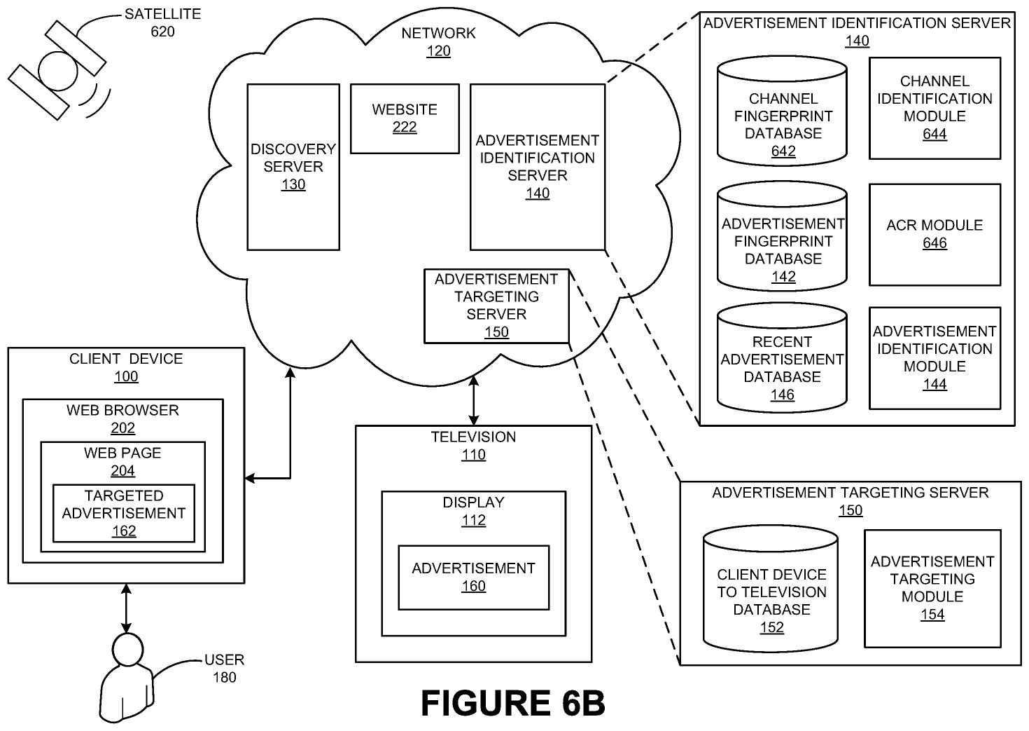

Reference is now made to FIGS. 6A-B, which is a block diagram of a system of targeted advertising to the client device 100 based on the advertisement 160 displayed on the television 110, wherein the advertisement 160 is identified based on a channel the television 110 is tuned to. The advertisement identification server 140 may be located within a studio or household receiving one or more channels, within a cable television head end, in a satellite uplink, or in a market where the content is distributed earlier. The advertisement identification server 140 may identify a channel based on one or more fingerprints from the television 110, and may run a separate ACR to generate detailed fingerprints at the location of the advertisement identification server 140. This system allows for more intense processing to be performed at the location of the advertisement identification server 140, which may have access to greater computing power than by the television 110. Further, this system circumvents issues that arise if the ACR (e.g. a third party ACR) run on the television 110 does not provide fingerprints suitable for advertisement identification.

In one or more embodiments, the advertisement identification server 140 may comprise a channel fingerprint database 642 and a channel identification module 644. The channel identification module 644 may receive, directly or indirectly, fingerprints from the television 110. The channel identification module may identify a channel the television 110 is tuned to by comparing the fingerprints to the channel fingerprint database 642. An ACR module 646 of the advertisement identification server 140 may generate detailed fingerprints from the identified channel (e.g. from a video feed, a frame buffer, or another source of channel-specific video data). The advertisement identification module 144 may identify the advertisement 160 being displayed on the television 110 based on a comparison of the detailed fingerprints generated to the advertisement fingerprint database 142. The advertisement identification module 144 may catalogue (i.e. store information relating to) the identified advertisement 160 in the recent advertisement database 146.

In one or more embodiments, the channel identification module 644 may infer the channel being rendered by the television 110 by comparing fingerprints from the television 110 with fingerprints received from an authoritative source such as a dedicated capture infrastructure. The dedicated capture may comprise a capture device receiving video from a cable, satellite 620, terrestrial broadcast, or streaming channel. If fingerprints from the television 110 sufficiently match to fingerprints from the dedicated capture infrastructure then the channel is identified (meaning the television 110 is inferred to be rendering the identified channel).

In one or more embodiments, the advertisement targeting module 154 may access the client device to television database 152 and/or the recent advertisement database 146. The advertisement targeting module 154 may target an advertisement 162 to the client device 100 based on an identified advertisement displayed on a television inferred to be associated with the client device. The advertisement targeting module 154 may target the advertisement 162 through the application 102 to the client device 100, as shown in FIG. 6A. Further embodiments involving targeted advertising through the application 102 have been discussed in FIG. 1, and are within the scope of the embodiments disclosed herein. Alternatively, the advertisement targeting module 154 may target the advertisement 162 through the website 222 and/or web browser 202 to the client device 100, as shown in FIG. 6B. Further embodiments involving targeted advertising through the website 222 and/or web browser 202 have been discussed in FIG. 2, and are within the scope of the embodiments disclosed herein.

In one or more embodiments, the advertisement identification server 140 may be placed (e.g. within a studio or household receiving one or more channels, within a cable television head end, in a satellite uplink, or in a market where the content is distributed earlier) to receive one or more fingerprints from an advertisement 160 before the television displays the advertisement 160. The advertisement identification server 140 and may therefore be capable of identifying the advertisement before it is displayed on the television 110. The advertisement targeting server 150 may target the advertisement 162 to the client device 100 before the advertisement 160 is displayed on the television 110. In one or more embodiments, the advertisement 162 may be a continuation advertisement (e.g. may refer to or lead into content of the advertisement 160 at the time or before the advertisement 160 is displayed).

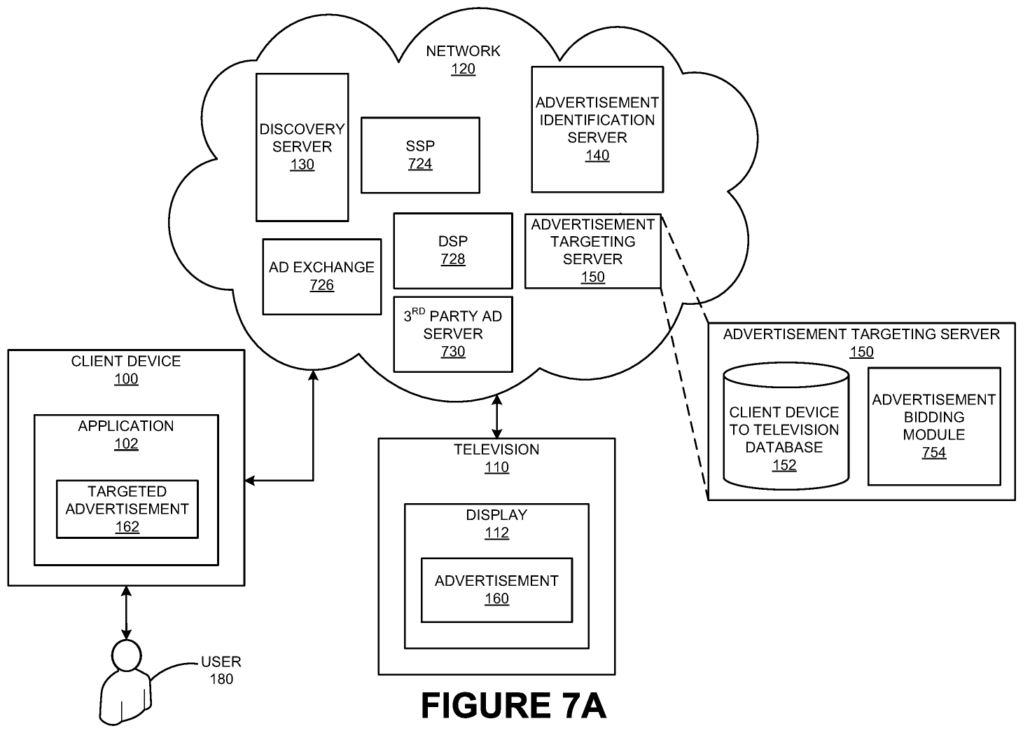

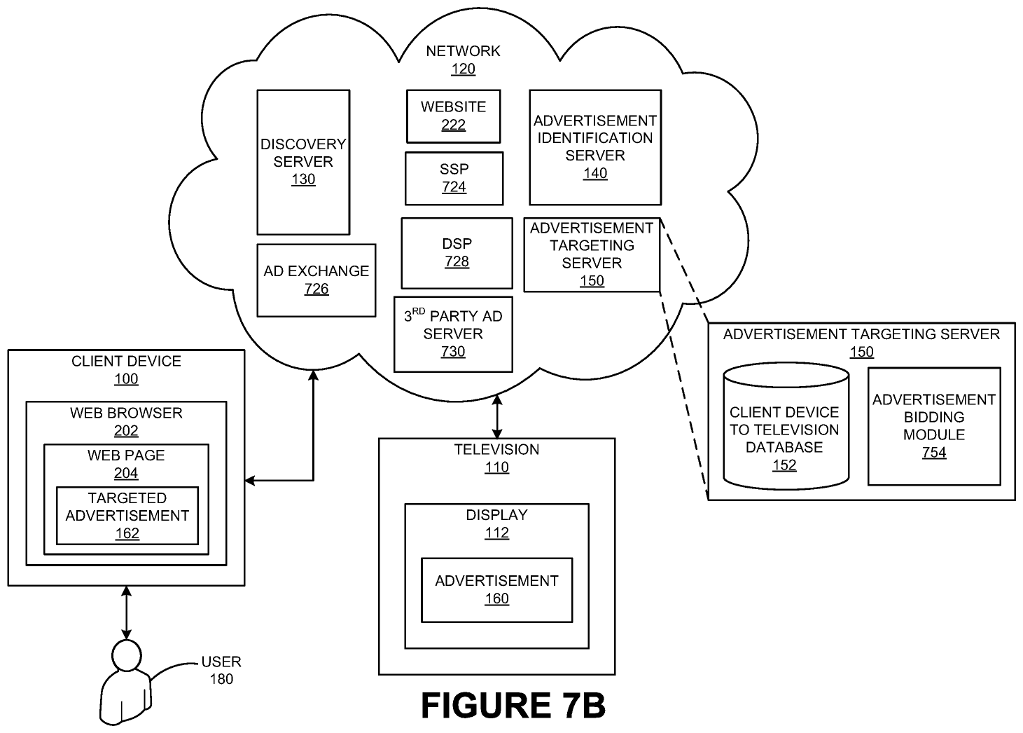

Reference is now made to FIGS. 7A-B, which is a block diagram of a system of targeted advertising to a client device 100, through an ad exchange 726 and an application 102, based on an advertisement 160 displayed on a television 110. The ad exchange 726 may allow for advertisements to be targeted to a wider range of client devices. Further, the prices set by the ad exchange 726 may not take into account the identified advertisement 160 and/or an inferred association between the client device 100 and the television 110. An arbitrage may be possible when an advertiser, if given the additional information of the identified advertisement 160 and/or the inferred association between the client device 100 and the television 110, would be willing to bid (e.g. pay, buy) for an advertisement spot at a higher price than the advertising spot is being sold for.

In one or more embodiments, the ad exchange 726 may be coupled to a supply side platform (SSP) 724 that aggregates one or more applications, configured for advertisement placement, across a number of client devices. The ad exchange 726 may be coupled to a demand side platform (DSP) 728 that aggregates one or more advertisers (e.g. single party advertisers, ad agencies, etc.). The ad exchange 726 may open, to the DSP 728, a bid request for an advertisement spot. A 3^{rd} party server 730 may target an advertisement to the advertisement spot based on a bid (e.g. sale) on the advertisement spot.

In one or more embodiments, an advertisement bidding module 754 of the advertisement targeting server 150 may bid in real time, through the ad exchange 726, to place an advertisement 162 on the client device 100. The advertisement bidding module 754 may bid based on an identification of the advertisement 160 of the television 110 and an inferred association of the client device 100 and the television 110. Further, the advertisement bidding module 754 may bid based on a price the advertiser of the advertisement 162 is willing to pay for placement of the advertisement 162 on the client device.

Further, the ad exchange 726 may sell the advertisement spot with the associated content ID on the ad exchange 726 for a higher price than the original advertisement spot. The content ID may identify the inferred association between the client device 100 and the television 110 and/or the advertisement 160 displayed by the television 110). An advertiser may be interested to bid on the advertisement spot when it is associated with the content ID. The advertisement bidding module 754 may be configured to wait to bid on the original advertisement spot until a buyer bids on the advertisement spot associated with the content ID. If a penalty is given for unsatisfied sales, the advertisement bidding module may be further configured to open a bid on the advertisement spot associated with the content ID based on the penalty and a risk that the penalty would be incurred.

In one or more embodiments, the SSP 724 and/or ad exchange 726 may obtain at least one of a content ID (e.g. one or more identifiers of the advertisement 160 and/or other content displayed by the television 110) and associate at least one of the content ID with an advertisement spot. In one or more embodiments, the content ID may be a brand, product, product line, or advertiser of the advertisement 160. Alternatively or in addition, the content ID may be an object, person, and/or location featured on a channel the television is tuned to.

In one or more embodiments, the advertisement bidding module 754 may be configured to bid under certain conditions (e.g. degree of certainty of an association between the client device 100 and the television 110, degree of certainty that the advertisement 160 was correctly identified, price of targeting the advertisement 162 as determined by the ad exchange 762, etc.) predetermined by the advertiser of the advertisement 162. Further, the advertisement bidding module 754 may be configured to bid when the advertiser is willing to pay more (e.g. based on the advertisement 160 and/or the inferred association between the client device 100 and the television 110) than a current bidding price to place the advertisement 162.

In FIG. 7A, the advertisement spot may be available on and/or through an application 102 of the client device 100.

In FIG. 7B, the advertisement spot may be available on and/or through a website 222. In one embodiment, the website 222 serves a web page that includes a URL in an HTML tag (e.g., an IMG, IFRAME, or FRAME tag) that causes the web browser 202 to send a request to the ad exchange 726 or the SSP 724. Because such tags on web page 204 are usually invisible to the user 180, they are called “tracking pixels.”

For example, the web page 204 from website 222 may contain the following tracking pixel HTML tag:
<IFRAME SRC=“http://example.adex.com/pixel”/>

The iframe tag above may cause the web browser 202 to download a web page from the ad exchange 726 containing one or more HTML tags that cause the web browser 202 to send a request to an advertisement targeting server 150. For example, the request may be:
<IMG SRC=“http://example.adex.com/pixel?buyer=advertisementtargetingserver150” width=1 height=1/>

Alternatively, website 222 may directly contain the above IMG tag without first loading an iframe or frame from the ad exchange 726 or the SSP 724. The IMG tag above may cause the web browser 202 to send a request to the ad exchange 726 or a SSP 724. For example, the request may be:
GET /pixel?buyer=advertisementtargetingserver150 HTTP/1.1
Host: example.adex.com
Cookie: user=user180
   where user180 represents a user ID for user 180, and advertisementtargetserver150 may be mapped by the advertisement targeting server 150 to the ad exchange 726. For the purposes of illustration, the advertisement targeting server may have previously provided to the ad exchange 726 or SSP 724 the following URL:
http://example.adtargetingserver150.com/pixel

The ad exchange 726 or the SSP 724 maps the advertisementtargetingserver150 id on to the URL provided above and then the ad exchange 726 or the SSP 724 appends a user identifier for user 180 that is mapped from, derived from, or equal to the user ID communicated in the cookie user=user180. For example, the URL may be:
http://example.advertisementtargetingserver150.com/pixel?user=user180

The ad exchange 726 or the SSP 724 returns to the web browser 202 a redirect (e.g., an HTTP 302) specifying the URL above as the location of the redirect. The web browser 202 then sends a request to the advertisement targeting server 150. For example, the request may be:
GET/pixel?user=user180
Host: example.adex.com

When the request arrives at the advertisement targeting server 150, the advertisement targeting server 150 need only look at the IP packet headers of the request to determine the public IP address of the web browser 202. Thus the advertisement targeting server 150 now has two pieces of information: the public IP address of the web browser 202 and the user ID (e.g. of user 180) of the ad exchange 726 associated with the web browser 202.

The advertisement targeting server 150 then queries the device database 132 for any televisions behind or associated with the public IP or the address range containing the public IP. If any exist (e.g. television 110), the advertisement targeting server 150 may update the client device to television database 152 to reflect the association between the client device 100 and the television 110. Furthermore the advertisement targeting server 150 associates with the client device the ad exchange's user ID user. The advertisement targeting server 150 may then tell the advertisement bidding module 754 to begin placing bids on bid requests from the ad exchange 176 for user 180, based on any recent advertisement 160 displayed on television 110, to place a targeted advertisement 162 on client device 100.

In the embodiments illustrated above, the website 222 is used only to obtain a mapping between client device 100 and television 110 and between the client device 100 and the user ID (e.g. of user 180) of the ad exchange 726. Any bidding performed by the advertisement bidding module 754 for advertisement spots associated with user 180 may refer to any web site that is selling advertisement spots on the ad exchange 726 and is thus not limited to the website 222 that contained the tracking pixel.

We can extend the examples above to confirm that the web browser 202 is on the same private network with the television 110 if it is behind the same public IP address or public IP address range. In response to the redirection request from the web browser 202 to the advertisement targeting server 150, the advertisement targeting server 150 could respond with a redirect to the private IP address of the television 110. For the purposes of illustration, the television 110 has a private IP address 192.168.1.14, and thus the location URL of the redirect from the advertisement targeting server 150 may be:
HTTP/1.1 302 Found
Location: http://192.168.1.14:8080/disambiguate?user=U

If the browser successfully opens a connection to 192.168.1.14, then the TV knows the user 180 (e.g. with user ID U) is on the same private network with television 110 and is running on the device with private IP revealed in the request's IP packet headers and the MAC address revealed in the request's frame headers. The MAC address may be used to generate a long-term identifier for the client device 100 used by user 180 (e.g. with the user ID U). The television 110 may also take the opportunity to use other protocols that only work between devices on the same network, such as uPnP, to further interrogate the client device to determines its offered services which often includes a description of the device including its make and/or model. The television 110 may then communicate its confirmed association with user 180 on the web browser 202 running on the client device 100 with determined MAC address and/or MAC-address-derived long-term identifier and with any other information determined by interrogating the client device 100 back to the advertisement targeting server 150. The advertisement targeting server 150 may then store the confirmed association in the client device to television database 152.

It should be noted that the operations discussed above may be performed based on executing instructions embodied in a non-transitory medium (e.g., a Compact Disc (CD), a Digital Video Disc (DVD), a hard drive) readable through a data processing device (e.g., client device 100, television 110) and/or a server (e.g., content identification server 1006 and/or relevancy-matching server 200 of U.S. Pat. No. 8,819,255) and executable therethrough.

Although the present embodiments have been described with reference to specific example embodiments, it will be evident that various modifications and changes may be made to these embodiments without departing from the broader spirit and scope of the various embodiments. For example, the discovery server 130, the advertisement identification server 140, and the advertisement targeting server 150 may all be in on central location (i.e. part of one server). Further, the databases and modules of each server may be organized differently (i.e. may be on different servers) in one or more embodiments. Accordingly, the specification and drawings are to be regarded in an illustrative in rather than a restrictive sense.

What is claimed is:

1. A server comprising:
a memory; and
a processor communicatively coupled to the memory, the processor configured to execute instructions to:
receive a request for content for a client device, the request comprising identification information,
match a targeted data to the identification information based on a relevancy factor, and
provide the targeted data to a sandboxed application of the client device configured to render the targeted data,
wherein the identification information is one of a user identification information and a device identification information for the client device, and
wherein the identification information is associated with one of: a content identification data and a content identification history generated from preliminary data generated by a networked device associated with the client device.

2. The server of claim 1, wherein the networked device comprises a frame buffer and wherein the preliminary data comprises fingerprint data generated from a plurality of images stored in the frame buffer.

3. The server of claim 2, wherein the preliminary data comprises fingerprint data generated from a video data stream received by the networked device.

4. The server of claim 3, wherein the request for content for the client device comprises a bid request for an advertising spot on the client device.

5. The server of claim 4, wherein one of:
the association between the networked device and the client device is determined based on a geospatial proximity,
the association between the networked device and the client device is determined through a shared Internet Protocol (IP) address range,
the association between the networked device and the client device is determined through a shared IP address,
the association between the networked device and the client device is determined through a shared base station MAC address,
the association between the networked device and the client device is determined through a shared base station SSID, and
the association between the networked device and the client device is determined through a shared user identifier.

6. A method of a server comprising:
receiving through a network a request for content for a client device comprising identification information;
storing the request in a memory; and
through a processor communicatively coupled to the memory, matching a targeted data to the identification information based on a relevancy factor, and providing the targeted data to a sandboxed application of the client device configured to render the targeted data,
wherein the identification information is one of: a user identification information and a device identification information for the client device, and
wherein the identification information is associated with one of: a content identification data and a content identification history generated from preliminary data generated by a networked device associated with the client device.

7. The method of claim 6, wherein the preliminary data comprises fingerprint data generated from a plurality of images stored in a frame buffer of the networked device.

8. The method of claim 7, wherein the preliminary data comprises fingerprint data generated from a video data stream received by the networked device.

9. The method of claim 8, wherein the request for content for the client device comprises a bid request for an advertising spot on the client device.

10. The method of claim 9, wherein one of:
the association between the networked device and the client device is determined based on a geospatial proximity,
the association between the networked device and the client device is determined through a shared IP address range,
the association between the networked device and the client device is determined through a shared IP address,
the association between the networked device and the client device is determined through a shared base station MAC address,
the association between the networked device and the client device is determined through a shared base station SSID, and
the association between the networked device and the client device is determined through a shared user identifier.

11. A system comprising:
a content identification server comprising a first memory and a first processor communicatively coupled to the first memory,
the first processor configured to execute instructions to:
receive fingerprint data generated at regular intervals by a networked device,
generate content identification data from the received fingerprint data, and
associate the content identification data with one of a device identification information and a user identification information; and
a relevancy-matching server comprising a second memory and a second processor communicatively coupled to the second memory,
the second processor configured to execute instructions to:
receive a request for content for a client device associated with the networked device, the request comprising the one of the device identification information and the user identification information associated with the content identification data,
match a targeted data to the one of the device identification information and the user identification information based on the association of the one of the device identification information and the user identification information with the content identification data, and
provide the targeted data to the client device through a sandboxed application of the client device configured to render the targeted data.

12. The system of claim 11, wherein the networked device comprises a frame buffer and wherein the fingerprint data is generated from a plurality of images stored in the frame buffer.

13. The system of claim 12, wherein the fingerprint data is generated from a video data stream received by the networked device.

14. The system of claim 13, wherein the request for content for the client device comprises a bid request for an advertising spot on the client device.

15. The system of claim 14, wherein one of:
the association between the networked device and the client device is determined based on a geospatial proximity,
the association between the networked device and the client device is determined through a shared IP address range,
the association between the networked device and the client device is determined through a shared IP address,
the association between the networked device and the client device is determined through a shared base station MAC address,
the association between the networked device and the client device is determined through a shared base station SSID, and
the association between the networked device and the client device is determined through a shared user identifier.

16. A method comprising:
through a content identification server comprising a first memory and a first processor communicatively coupled to the first memory,
the first processor receiving fingerprint data generated at regular intervals by a networked device,
the first processor generating content identification data from the received fingerprint data, and
the first processor associating the content identification data with one of a device identification information and a user identification information; and
through a relevancy-matching server comprising a second memory and a second processor communicatively coupled to the second memory,
the second processor receiving a request for content for a client device associated with the networked device comprising the one of the device identification information and the user identification information associated with the content identification data, and
the second processor, in response to the request for content,
matching a targeted data to the one of the device identification information and the user identification information based on the association of the one of the device identification information and the user identification information with the content identification data, and
providing the targeted data to the client device through a sandboxed application of the client device configured to render the targeted data.

17. The method of claim 16, wherein the networked device comprises a frame buffer and wherein the fingerprint data is generated from a plurality of images stored in the frame buffer.

18. The method of claim 17, wherein the fingerprint data is generated from a video data stream received by the networked device.

19. The method of claim 18, wherein the request for content for the client device comprises a bid request for an advertising spot on the client device.

20. The method of claim 19, wherein one of:
the association between the networked device and the client device is determined based on a geospatial proximity,
the association between the networked device and the client device is determined through a shared IP address range,
the association between the networked device and the client device is determined through a shared IP address,
the association between the networked device and the client device is determined through a shared base station MAC address,
the association between the networked device and the client device is determined through a shared base station SSID, and
the association between the networked device and the client device is determined through a shared user identifier.
